(19) United States
(12) Patent Application Publication
(10) Pub. No.: US 2025/0259785 A1
(43) Pub. Date: Aug. 14, 2025

(54) INDUCTOR COMPONENT

(71) Applicant: Murata Manufacturing Co., Ltd., Kyoto-fu (JP)

(72) Inventors: Ryuichiro TOMINAGA, Nagaokakyo-shi (JP); Keisuke KUNIMORI, Nagaokakyo-shi (JP); Yuuki KAWAKAMI, Nagaokakyo-shi (JP)

(73) Assignee: Murata Manufacturing Co., Ltd., Kyoto-fu (JP)

(21) Appl. No.: 19/195,848

(22) Filed: May 1, 2025

Related U.S. Application Data
(63) Continuation of application No. PCT/JP2023/029300, filed on Aug. 10, 2023.

(30) Foreign Application Priority Data
Nov. 8, 2022 (JP) 2022-178846

(51) Int. Cl. H01F 27/32; H01F 17/00

(52) U.S. Cl. CPC H01F 27/324; H01F 17/0006; H01F 2017/004

(57) ABSTRACT

An inductor component is capable of improving inductance value. The inductor component comprises element body including magnetic layer, coil disposed in element body and having shaft, and insulating layer covering apart of outer surface of coil. The coil includes inductor wiring wound along plane orthogonal to axis. The inductor wiring has first surface and second surface facing each other in axial direction. At least a part of first surface of inductor wiring is in contact with magnetic layer.

### CROSS REFERENCE TO RELATED APPLICATION

This application claims benefit of priority to International Patent Application No. PCT/JP2023/029300, filed Aug. 10, 2023, and to Japanese Patent Application 2022-178846 filed Nov. 8, 2022, the entire content of each are incorporated herein by reference.

### BACKGROUND

### Technical Field

The present disclosure relates to an inductor component.

### Background Art

Conventionally, as an inductor component, there is an inductor component described in Japanese Patent Application Laid-Open No. 2021-174799. The inductor component includes an element body including a magnetic layer and a coil disposed in the element body and having an axis. The entire outer surface of the coil is covered with an insulating material.

### SUMMARY

However, in the conventional inductor component, since the entire outer surface of the coil is covered with the insulating material, the volume of the magnetic layer cannot be secured, and a desired inductance value may not be obtained.

Therefore, the present disclosure provides an inductor component capable of improving an inductance value.

Accordingly, an inductor component which is one aspect of the present disclosure includes an element body including a magnetic layer; a coil disposed in the element body and having a shaft; and an insulating layer covering a part of an outer surface of the coil. The coil includes an inductor wiring wound along a plane orthogonal to the axis, the inductor wiring has a first surface and a second surface facing each other in the axial direction, and at least a part of the first surface of the inductor wiring is in contact with the magnetic layer.

According to the above aspect, since at least a part of the first surface of the inductor wiring is in contact with the magnetic layer, the volume of the magnetic layer can be increased as compared with a case where the entire outer surface of the inductor wiring is covered with the insulating material. As a result, the inductance value of the inductor component can be improved.

According to the inductor component which is one aspect of the present disclosure, the inductance value can be improved.

### BRIEF DESCRIPTION OF THE DRAWINGS

FIG. 1 is a schematic plan view illustrating a first embodiment of an inductor component.

FIG. 2 is a cross-sectional view taken along line II-II of FIG. 1.

FIG. 3 is an enlarged view of a portion A in FIG. 2.

FIG. 4 is a schematic cross-sectional view illustrating a modification of the inductor component.

FIG. 5A is an explanatory diagram for explaining a manufacturing method of the inductor component.

FIG. 5B is an explanatory diagram for explaining the manufacturing method of the inductor component.

FIG. 5C is an explanatory diagram for explaining the manufacturing method of the inductor component.

FIG. 5D is an explanatory diagram for explaining the manufacturing method of the inductor component.

FIG. 5E is an explanatory view for explaining the manufacturing method of the inductor component.

FIG. 5F is an explanatory diagram for explaining the manufacturing method of the inductor component.

FIG. 5G is an explanatory diagram for explaining the manufacturing method of the inductor component.

FIG. 5H is an explanatory diagram for explaining the manufacturing method of the inductor component.

FIG. 5I is an explanatory diagram for explaining the manufacturing method of the inductor component.

FIG. 5J is an explanatory diagram for explaining the manufacturing method of the inductor component.

FIG. 6 is a schematic cross-sectional view illustrating a second embodiment of an inductor component.

FIG. 7 is a schematic cross-sectional view illustrating a third embodiment of an inductor component.

FIG. 8 is a schematic plan view illustrating a fourth embodiment of an inductor component.

### DETAILED DESCRIPTION

Hereinafter, an inductor component which is one aspect of the present disclosure will be described in detail with reference to the illustrated embodiments. Note that the drawings include some schematic drawings, and may not reflect actual dimensions and ratios.

### First Embodiment

### (Configuration)

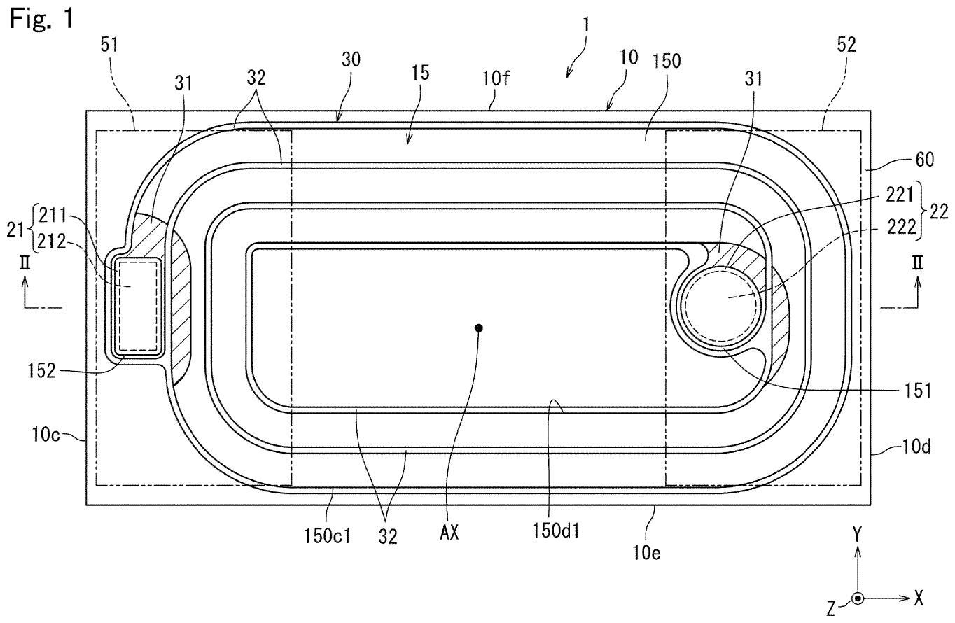

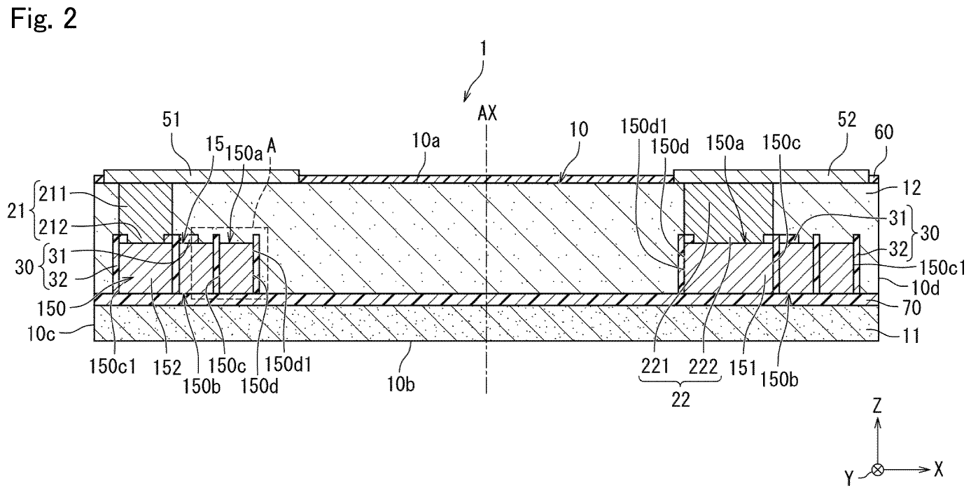

FIG. 1 is a schematic plan view illustrating a first embodiment of an inductor component. FIG. 2 is a cross-sectional view taken along line II-II of FIG. 1. In FIG. 1, for convenience, hatching is applied to a position where a top surface portion of a covering insulating layer exists. In FIG. 2, a seed layer is omitted for convenience. FIG. 2 corresponds to an example of a “cross section orthogonal to an extending direction of an inductor wiring” described in the claims.

An inductor component 1 is mounted on an electronic device such as a personal computer, a DVD player, a digital camera, a TV, a mobile phone, or car electronics, and is, for example, a component having a rectangular parallelepiped shape as a whole. However, the shape of the inductor component 1 is not particularly limited, and may be a cylindrical shape, a polygonal columnar shape, a truncated cone shape, or a polygonal frustum shape.

As illustrated in FIGS. 1 and 2, the inductor component 1 includes an element body 10, a coil 15 disposed in the element body 10 and having an axis AX, a covering insulating layer 30 and an underlying insulating layer 70 covering a part of an outer surface of the coil 15, a first external terminal 51 and a second external terminal 52 exposed on a first main surface 10a of the element body 10, and a covering film 60 provided on the first main surface 10a of the element body 10. The covering insulating layer 30 and the underlying insulating layer 70 correspond to an example of an “insulating layer” described in the claims.

The shape of the element body 10 is not particularly limited, but is a rectangular parallelepiped shape in this embodiment. The outer surface of the element body 10 has the first main surface 10a and a second main surface 10b, and a first side surface 10c, a second side surface 10d, a third side surface 10e, and a fourth side surface 10f that are located between the first main surface 10a and the second main surface 10b and connect the first main surface 10a and the second main surface 10b. The first main surface 10a and the second main surface 10b face each other. The first side surface 10c and the second side surface 10d face each other. The third side surface 10e and the fourth side surface 10f face each other.

In the drawing, a thickness direction of the element body 10 is defined as a Z direction, a direction from the second main surface 10b toward the first main surface 10a is defined as a forward Z direction, and a reverse direction of the forward Z direction is defined as a reverse Z direction. In this specification, of the first main surface 10a and the second main surface 10b, the main surface side on which the external terminals 51 and 52 are provided is defined as an upper side. In this embodiment, the forward Z direction is the upper side. In a plane orthogonal to the Z direction of the element body 10, a length direction that is a longitudinal direction of the element body 10 and is a direction in which the first external terminal 51 and the second external terminal 52 are arranged is defined as an X direction, and a width direction of the element body 10 that is a direction orthogonal to the length direction is defined as a Y direction. Further, in the X direction, a direction from the first side surface 10c toward the second side surface 10d is defined as a forward X direction, and a reverse direction of the forward X direction is defined as a reverse X direction. In the Y direction, a direction from the third side surface 10e toward the fourth side surface 10f is defined as a forward Y direction, and a reverse direction of the forward Y direction is defined as a reverse Y direction. The forward Z direction corresponds to an example of a “first direction” described in the claims. The reverse Z direction corresponds to an example of a “second direction” described in the claims.

The element body 10 includes a first magnetic layer 11 and a second magnetic layer 12 sequentially arranged along the forward Z direction. This “order” merely indicates the positional relationship between the first magnetic layer 11 and the second magnetic layer 12, and is not related to the order of formation of the first magnetic layer 11 and the second magnetic layer 12. The first magnetic layer 11 and the second magnetic layer 12 correspond to an example of a “magnetic layer” described in the claims.

The first magnetic layer 11 and the second magnetic layer 12 each contain magnetic powder and a resin containing the magnetic powder. The resin is, for example, an organic insulating material that is epoxy, a mixture of epoxy and acrylic, or epoxy, or a mixture of acrylic and other materials. The magnetic powder is, for example, a FeSi-based alloy such as FeSiCr, a FeCo-based alloy, a Fe-based alloy such as NiFe, or an amorphous alloy thereof. The magnetic powder may be ferrite. The average particle diameter of the magnetic powder is preferably 5 μm or less. Note that the first magnetic layer 11 and the second magnetic layer 12 may not contain an organic resin, such as a sintered body of ferrite or magnetic powder.

The coil 15 includes an inductor wiring 150 and a first extended wiring 21 and a second extended wiring 22 provided in the element body 10 such that the end surface is exposed from the first main surface 10a of the element body 10. The inductor wiring refers to a wiring spirally wound on a plane including the inner peripheral end 151 and the outer peripheral end 152. The coil is a member including a wiring (in this embodiment, the first and second extended wirings 21 and 22) for extracting a signal of the inductor wiring to the outside of the element body 10 in addition to the inductor wiring. The inductor wiring 150 is wound along a plane (XY plane) orthogonal to the axis AX of the coil 15 between the first magnetic layer 11 and the second magnetic layer 12. Specifically, the first magnetic layer 11 exists in the reverse Z direction with respect to the inductor wiring 150, and the second magnetic layer 12 exists in the forward Z direction with respect to the inductor wiring 150 and in the direction orthogonal to the forward Z direction.

The inductor wiring 150 is spirally wound in a clockwise direction from the outer peripheral end 152 toward the inner peripheral end 151 when viewed from the Z direction.

The number of turns of the inductor wiring 150 is preferably 1 turn or more. Accordingly, the inductance value can be improved. One turn or more means a state in which the inductor wiring has a portion that is adjacent in the radial direction as viewed from the axial direction and runs parallel in the winding direction in the cross section orthogonal to the axis of the inductor wiring, and less than one turn means a state in which the inductor wiring does not have a portion that is adjacent in the radial direction as viewed from the axial direction and runs parallel in the winding direction in the cross section orthogonal to the axis. In this embodiment, the number of turns of the inductor wiring 150 is 2.5 turns.

The inductor wiring 150 has a top surface 150a and a bottom surface 150b facing each other in the axis AX direction of the coil 15. Specifically, the inductor wiring 150 has the top surface 150a facing the forward Z direction (that is, the upper side) and the bottom surface 150b facing the reverse Z direction. In this specification, the top surface 150a of the inductor wiring 150 does not include a connection portion with the first and second extended wirings 21 and 22. The top surface 150a corresponds to an example of a “first surface” described in the claims. The bottom surface 150b corresponds to an example of a “second surface” described in the claims. The inductor wiring 150 has both side surfaces 150c and 150d that connect the top surface 150a and the bottom surface 150b. Specifically, the inductor wiring 150 has the first side surface 150c facing radially outward and the second side surface 150d facing radially inward.

The outer peripheral end 152 of the inductor wiring 150 is connected to the first external terminal 51 via the first extended wiring 21 in contact with the top surface of the outer peripheral end 152. The inner peripheral end 151 of the inductor wiring 150 is connected to the second external terminal 52 via the second extended wiring 22 in contact with the top surface of the inner peripheral end 151. With the above configuration, the inductor wiring 150 is electrically connected to the first external terminal 51 and the second external terminal 52.

The inductor wiring 150 is preferably made of Au, Pt, Pd, Ag, Cu, Al, Co, Cr, Zn, Ni, Ti, W, Fe, Sn, In, or a compound thereof. The inductor wiring 150 is formed by, for example, electrolytic plating. The inductor wiring 150 may be formed by an electroless plating method, a sputtering method, a vapor deposition method, a coating method, or the like.

The first extended wiring 21 extends in the forward Z direction from the top surface of the outer peripheral end 152 of the inductor wiring 150 and penetrates the inside of the covering insulating layer 30 and the second magnetic layer 12. The first extended wiring 21 is preferably made of Cu, Ag, Au, Fe, or a compound thereof. The first extended wiring 21 includes a first via wiring 212 that is provided on the top surface of the outer peripheral end 152 of the inductor wiring 150 and penetrates the inside of the covering insulating layer 30, and a first columnar wiring 211 that extends in the forward Z direction from the top surface of the first via wiring 212, penetrates the inside of the second magnetic layer 12, and has an end surface exposed to the first main surface 10a of the element body 10. The via wiring is a conductor having a line width (diameter and cross-sectional area) smaller than that of the columnar wiring.

The second extended wiring 22 extends in the forward Z direction from the top surface of the inner peripheral end 151 of the inductor wiring 150 and penetrates the insides of the covering insulating layer 30 and the second magnetic layer 12. The second extended wiring 22 is preferably made of Cu, Ag, Au, Fe, or a compound thereof. The second extended wiring 22 includes a second via wiring 222 that is provided on the top surface of the inner peripheral end 151 of the inductor wiring 150 and penetrates the inside of the covering insulating layer 30, and a second columnar wiring 221 that extends in the forward Z direction from the top surface of the second via wiring 222, penetrates the inside of the second magnetic layer 12, and has an end surface exposed to the first main surface 10a of the element body 10. The first and second extended wirings 21 and 22 are preferably made of the same material as that of the inductor wiring 150.

The first and second external terminals 51 and 52 are provided on the first main surface 10a of the element body 10. The first and second external terminals 41 and 42 are made of a conductive material, and have a three-layer configuration in which, for example, Cu having low electric resistance and excellent stress resistance, Ni having excellent corrosion resistance, and Au having excellent solder wettability and reliability are arranged in this order from the inside to the outside.

The first external terminal 51 is in contact with an end surface of the first extended wiring 21 exposed from the first main surface 10a of the element body 10, and is electrically connected to the first extended wiring 21. As a result, the first external terminal 51 is electrically connected to the outer peripheral end 152 of the inductor wiring 150. The second external terminal 52 is in contact with the end surface of the second extended wiring 22 exposed from the first main surface 10a of the element body 10, and is electrically connected to the second extended wiring 22. As a result, the second external terminal 52 is electrically connected to the inner peripheral end 151 of the inductor wiring 150. In FIG. 1, the first and second external terminals 51 and 52 are indicated by two-dot chain lines for convenience.

The covering insulating layer 30 and the underlying insulating layer 70 are made of an insulating material containing no magnetic body. The insulating material is preferably made of, for example, any of epoxy, acrylic, phenol, and polyimide, or a mixture thereof.

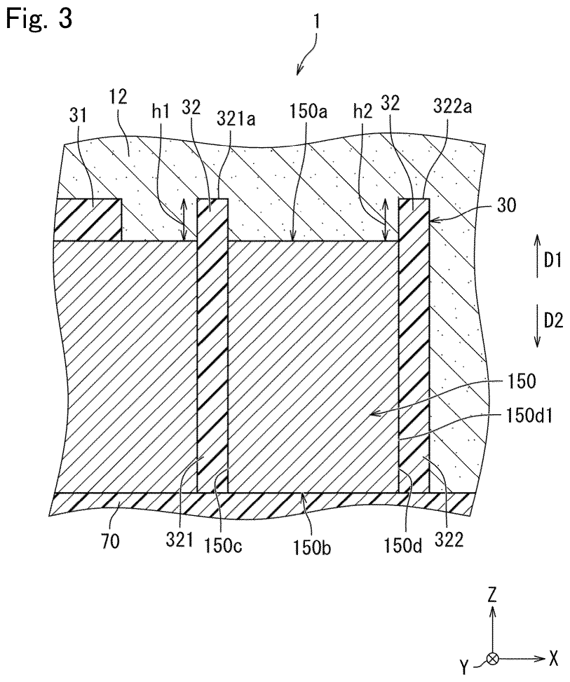

FIG. 3 is an enlarged view of a portion A in FIG. 2. As illustrated in FIG. 3, at least a part of the top surface 150a of the inductor wiring 150 is in contact with at least one of the first magnetic layer 11 and the second magnetic layer 12. In this embodiment, only a part of the top surface 150a of the inductor wiring 150 is in contact with the second magnetic layer 12.

Specifically, the underlying insulating layer 70 is laminated on the first magnetic layer 11 so as to cover the entire upper surface of the first magnetic layer 11. The inductor wiring 150 is laminated on the underlying insulating layer 70. The entire bottom surface 150b of the inductor wiring 150 is in contact with the upper surface of the underlying insulating layer 70.

The covering insulating layer 30 is provided on the underlying insulating layer 70 and covers a part of the outer surface of the inductor wiring 150. The covering insulating layer 30 has a top surface portion 31 and a wall portion 32.

The wall portion 32 is provided on at least one of the first side surface 150c and the second side surface 150d of the inductor wiring 150. In this embodiment, the wall portion 32 is provided on both the first side surface 150c and the second side surface 150d. The wall portion 32 extends in the Z direction in a cross section (that is, the cross section illustrated in FIG. 2) orthogonal to the extending direction of the inductor wiring 150. The wall portion 32 is in contact with the entire surface of the first side surface 150c and the entire surface of the second side surface 150d. The lower surface of the wall portion 32 is in contact with the upper surface of the underlying insulating layer 70. In short, the wall portion 32 is provided between an inner peripheral surface 150d1 of the innermost periphery of the inductor wiring 150, an outer peripheral surface 150c1 of the outermost periphery of the inductor wiring 150, and the turns of the inductor wiring 150.

The innermost periphery of the inductor wiring refers to the inner periphery on the radially inner side of the inductor wiring when the inductor wiring is less than one turn, and refers to the inner periphery on the radially inner side of a portion constituting one turn including the inner peripheral end in the inductor wiring when the inductor wiring is one turn or more. The outermost periphery of the inductor wiring refers to the outer periphery on the radially outer side of the inductor wiring when the inductor wiring is less than one turn, and refers to the outer periphery on the radially outer side of a portion constituting one turn including the outer peripheral end in the inductor wiring when the inductor wiring is one turn or more.

The top surface portion 31 is provided on apart of the top surface 150a of the inductor wiring 150. Specifically, the top surface portion 31 is provided in a predetermined range around the first extended wiring 21 in the top surface 150a of the inductor wiring 150 when viewed from the Z direction. The predetermined range is a range in which insulation between the top surface 150a of the inductor wiring and the first extended wiring 21 can be secured. In this embodiment, the shape of the predetermined range is a shape along the outer shape (rectangle) of the first extended wiring 21 when viewed from the Z direction. Thus, insulation between the top surface 150a of the inductor wiring and the first extended wiring 21 can be easily secured.

Similarly, the top surface portion 31 is provided in a predetermined range around the second extended wiring 22 in the top surface 150a of the inductor wiring 150 when viewed from the Z direction. The predetermined range is a range in which insulation between the top surface 150a of the inductor wiring and the second extended wiring 22 can be secured. In this embodiment, the shape of the predetermined range is a shape along the outer shape (circle) of the second extended wiring 22 when viewed from the Z direction. This makes it possible to easily ensure insulation between the top surface 150a of the inductor wiring and the second extended wiring 22.

A portion of the top surface 150a of the inductor wiring 150 where the top surface portion 31 of the covering insulating layer 30 is not provided is in contact with the second magnetic layer 12. With the above configuration, only a portion of the top surface 150a of the inductor wiring 150 where the top surface portion 31 of the covering insulating layer 30 is not provided is in contact with the second magnetic layer 12.

According to the inductor component 1, since at least a part of the top surface 150a of the inductor wiring 150 is in contact with any one of the first magnetic layer 11 and the second magnetic layer 12, the volumes of the first magnetic layer 11 and the second magnetic layer 12 can be increased as compared with a case where the entire outer surface of the inductor wiring 150 is covered with an insulating material. As a result, the inductance value of the inductor component 1 can be improved.

In particular, in an inductor component in which each of the area of the top surface 150a and the area of the bottom surface 150b of the inductor wiring 150 is larger than the area of the inner peripheral surface 150d1 of the innermost periphery of the inductor wiring 150, the above-described effect of increasing the volumes of the first magnetic layer 11 and the second magnetic layer 12 becomes larger than a case where only the inner peripheral surface 150d1 of the outer surface of the inductor wiring 150 is in contact with the second magnetic layer 12.

Preferably, as illustrated in FIG. 3, in the cross section orthogonal to the extending direction of the inductor wiring 150, the inductor wiring 150 has both side surfaces 150c and 150d connecting the top surface 150a and the bottom surface 150b, and the covering insulating layer 30 has the wall portion 32 provided on at least one of both the side surfaces 150c and 150d. Specifically, the covering insulating layer 30 includes a first wall portion 321 provided on the first side surface 150c and a second wall portion 322 provided on the second side surface 150d. According to this configuration, the inductor can suppress a short circuit between both the side surfaces 150c and 150d of the wiring 150 and another conductive member.

Preferably, when a direction from the bottom surface 150b of the inductor wiring 150 toward the top surface 150a in the axis AX direction is defined as a first direction D1, the end surface of the wall portion 32 in the first direction D1 is located closer to the first direction D1 than the position of the top surface 150a of the inductor wiring 150. Specifically, the first end surface 321a of the first wall portion 321 in the first direction D1 is located on the first direction D1 side with respect to the position of the top surface 150a of the inductor wiring 150. A second end surface 322a of the second wall portion 322 in the first direction D1 is located on the first direction D1 side with respect to the position of the top surface 150a of the inductor wiring 150. According to this configuration, the inductor can more reliably suppress a short circuit between both the side surfaces 150c and 150d of the wiring 150 and another conductive member.

Preferably, a distance in the first direction D1 between the top surface 150a of the inductor wiring 150 and the end surface of the wall portion 32 in the first direction D1 is 5 m or more and 20 μm or less (i.e., from 5 μm to 20 μm). Specifically, a distance h1 in the first direction D1 between the top surface 150a of the inductor wiring 150 and the first end surface 321a of the first wall portion 321 is 5 μm or more and 20 μm or less (i.e., from 5 μm to 20 μm). A distance h2 in the first direction D1 between the top surface 150a of the inductor wiring 150 and the second end surface 322a of the second wall portion 322 is 5 μm or more and 20 μm or less (i.e., from 5 μm to 20 μm).

According to the above configuration, since the distance h1 and the distance h2 are 5 μm or more, it is possible to prevent the inner peripheral surface 150d1 of the innermost periphery of the inductor wiring 150 from being short-circuited via the second magnetic layer 12. When the number of turns of the inductor wiring 150 is 1 or more as in this embodiment, a short circuit between adjacent turns can be suppressed. Since the distance h1 and the distance h2 are 20 μm or less, the inductor wiring 150 can be formed in a desired shape. As a result, a desired inductor value can be obtained. When the distance h1 and the distance h2 exceed 20 μm, there is a possibility that the wall portion 32 is inclined in the forward X direction or the reverse X direction after the wall portion 32 is formed, and the inductor wiring 150 cannot be formed into a desired shape. In addition, since the distance h1 and the distance h2 are 20 μm or less, the volume of the second magnetic layer 12 can be further increased.

As in this embodiment, when there are a plurality of wall portions 32 in the X direction in the cross section orthogonal to the extending direction of the inductor wiring 150, the distance is most preferably 5 μm or more and 20 μm or less (i.e., from 5 μm to 20 μm) in all the wall portions 32. However, the present disclosure is not limited thereto, and in a cross section orthogonal to the extending direction of the inductor wiring 150, the distance may be 5 m or more and 20 μm or less (i.e., from 5 μm to 20 μm) in some wall portions 32 among the plurality of wall portions 32.

Preferably, as illustrated in FIGS. 1 and 2, the covering insulating layer 30 is provided at least on a part of the top surface 150a of the inductor wiring 150. According to this configuration, it is possible to increase the volume of the second magnetic layer 12 while ensuring insulation between the top surface 150a and another conductive member.

Preferably, as illustrated in FIGS. 1 and 2, assuming that a direction from the bottom surface 150b of the inductor wiring 150 toward the top surface 150a in the axis AX direction is a first direction D1, the first and second extended wirings 21 and 22 connected to the top surface 150a at the end (that is, the inner peripheral end 151 and the outer peripheral end 152) in the extending direction of the inductor wiring 150, extending in the first direction D1, and exposed from the outer surface of the element body 10 are further provided, and the covering insulating layer 30 (that is, the top surface portion 31) provided in a part of the top surface 150a of the inductor wiring 150 is provided over a range of 80 μm or more from the peripheral edge of the first and second extended wirings 21 and 22 in the top surface 150a.

According to the above configuration, it is possible to suppress the occurrence of a short circuit between the portion of the top surface 150a of the inductor wiring 150 in contact with the second magnetic layer 12 and the first and second extended wirings 21 and 22. Specifically, when a potential difference is generated in the conductor portion of the inductor component 1 due to ESD (Electro Static Discharge; electrostatic discharge) or the like, a short circuit may occur via the magnetic powder of the second magnetic layer 12. In particular, since the distance between the first and second extended wirings 21 and 22 and the inductor wiring 150 existing around the first and second extended wirings 21 and 22 is relatively short, a short circuit easily occurs. The present inventors have found that even if a part of the top surface 150a of the inductor wiring 150 is brought into contact with the second magnetic layer 12 without being covered with the covering insulating layer 30, by providing the top surface portion 31 of the covering insulating layer 30 over a range of 80 μm or more from the peripheral edges of the first and second extended wirings 21 and 22, the short-circuit risk can be reduced to the same extent as in a case where the entire top surface 150a of the inductor wiring 150 is covered with the covering insulating layer 30.

### Modification

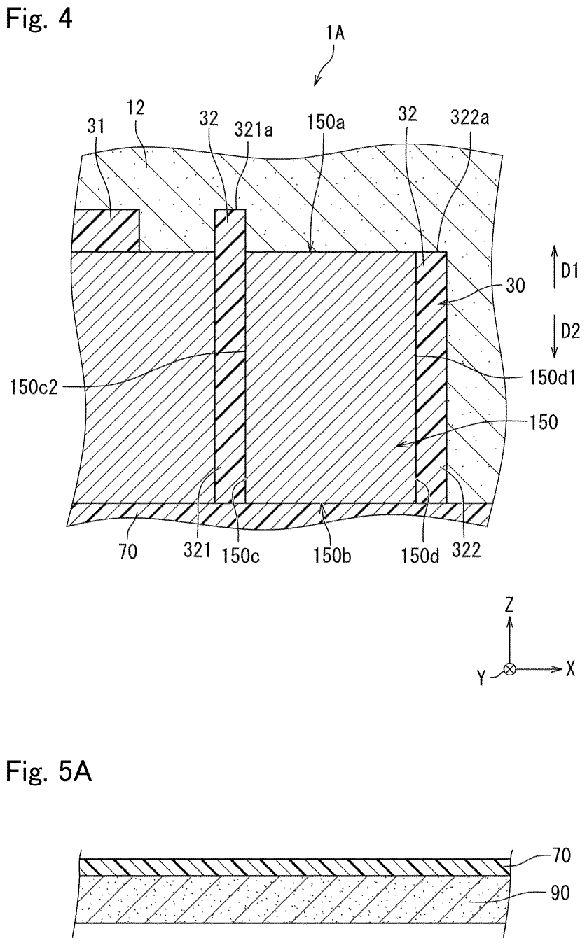

FIG. 4 is a schematic cross-sectional view illustrating an inductor component 1A according to a modification. FIG. 4 corresponds to FIG. 3.

As illustrated in FIG. 4, in a cross section orthogonal to an extending direction of an inductor wiring 150, the inductor wiring 150 has both side surfaces 150c and 150d connecting a top surface 150a and a bottom surface 150b, both the side surfaces 150c and 150d of the inductor wiring located on the innermost periphery include an inner peripheral surface 150d1 of an innermost periphery and an outer peripheral surface 150c2 facing the inner peripheral surface 150d1, a covering insulating layer 30 has at least a first wall portion 321 and a second wall portion 322 provided on each of the inner peripheral surface 150d1 and the outer peripheral surface 150c2, and an end surface 322a of the second wall portion 322 provided on the inner peripheral surface 150d1 in a first direction D1 is located on a second direction D2 side opposite to the first direction D1 with respect to an end surface 321a of the first wall portion 321 provided on the outer peripheral surface 150c2 in the first direction D1.

Here, when the number of turns of the inductor wiring 150 is less than 1 turn, the “both side surfaces of the inductor wiring located at the innermost periphery” refers to both side surfaces of the inductor wiring 150 in the cross section orthogonal to the extending direction of the inductor wiring 150. When the number of turns of the inductor wiring 150 is 1 turn or more, the “both side surfaces of the inductor wiring located on the innermost periphery” refers to both side surfaces in the cross section of the inductor wiring including the innermost periphery among the cross sections of the plurality of inductor wirings appearing in the cross section orthogonal to the extending direction of the inductor wiring 150.

According to the above configuration, it is possible to suppress the magnetic flux from being obstructed by the second wall portion 322 of the covering insulating layer 30 in the portion where the magnetic flux goes around.

Preferably, as illustrated in FIG. 4, the end surface 322a of the second wall portion 322 provided on the inner peripheral surface 150d1 in the first direction D1 is located on the same plane as the top surface 150a of the inductor wiring 150.

According to the above configuration, it is possible to further suppress the magnetic flux from being obstructed by the second wall portion 322 of the covering insulating layer 30 in the portion where the magnetic flux goes around.

### Production Method

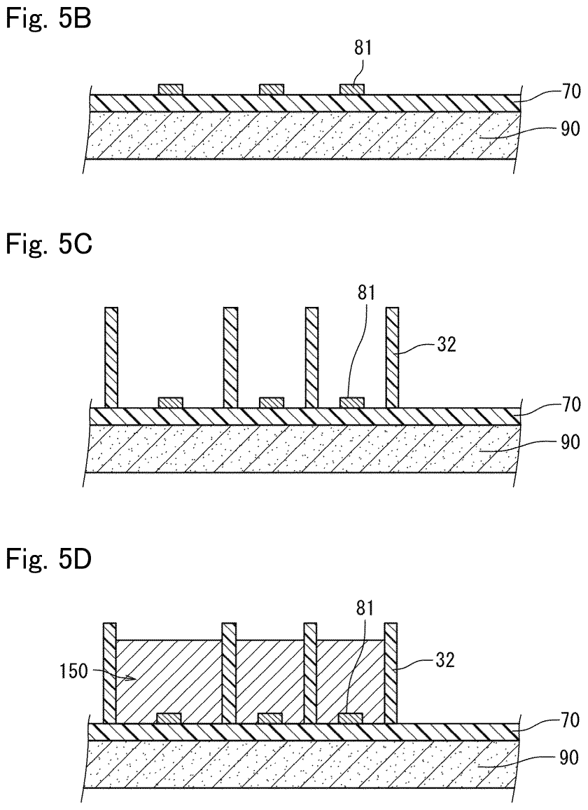

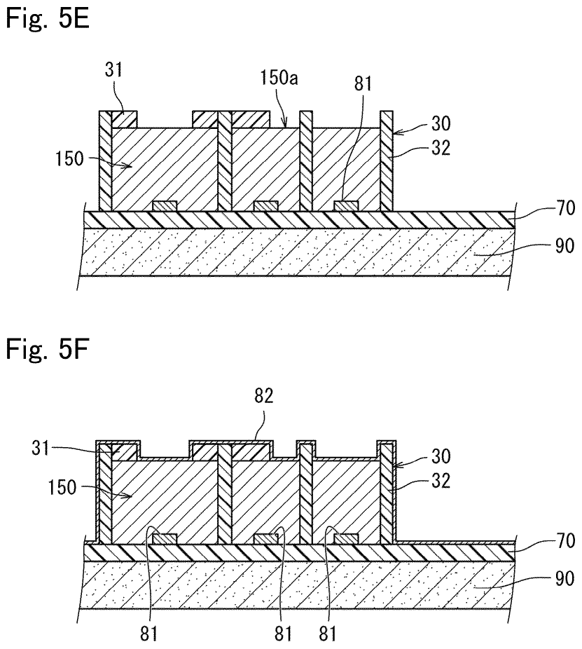

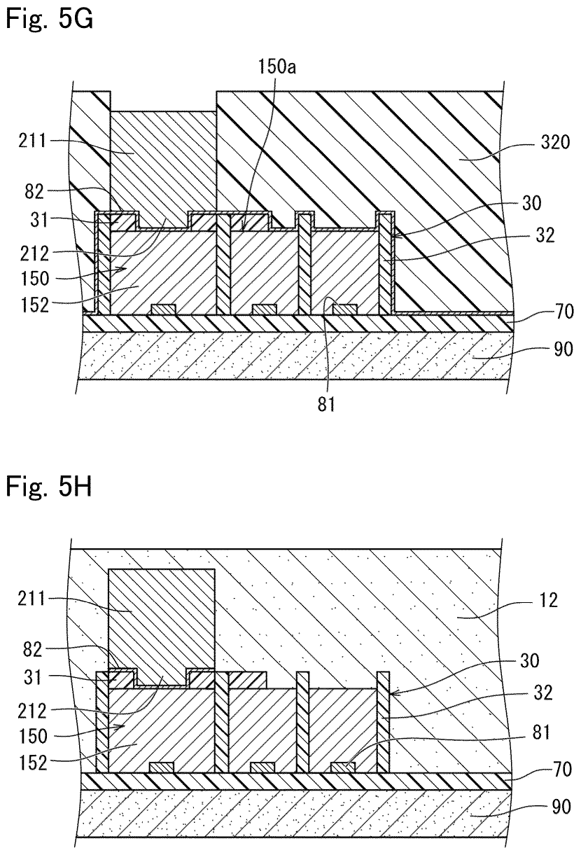

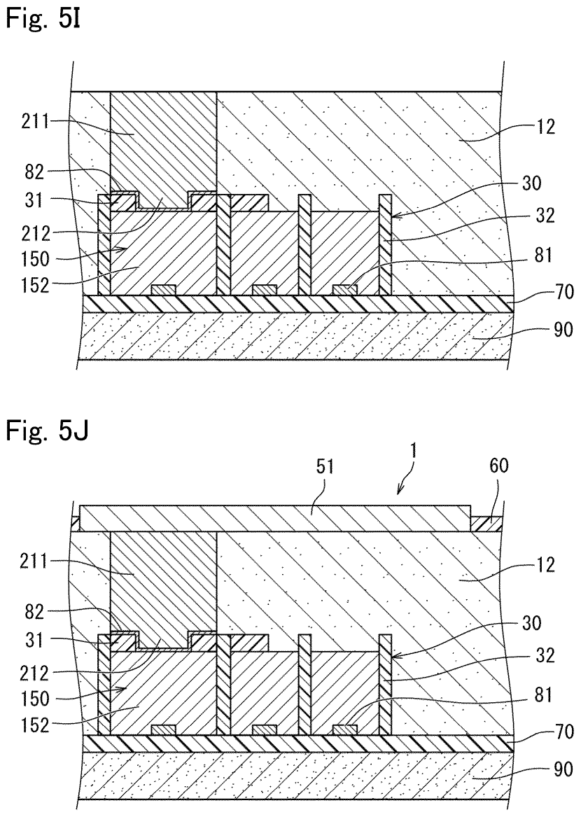

Next, a method for manufacturing the inductor component 1 will be described with reference to FIGS. 5A to 5J. FIGS. 5A to 5J correspond to the II-II cross section of FIG. 1 (FIG. 2). In FIGS. 5A to 5J, illustration of the second extended wiring side is omitted for convenience.

As illustrated in FIG. 5A, the underlying insulating layer 70 not containing a magnetic body is formed on a substrate 90. The substrate 90 is made of sintered ferrite, for example, and has a flat plate shape.

The underlying insulating layer 70 is made of, for example, a polyimide-based resin not containing a magnetic body. The underlying insulating layer 70 is formed by coating the substrate 90 with a polyimide-based resin by printing, coating, or the like. After the underlying insulating layer 70 is coated, only the polyimide-based resin in the region where the inductor wiring 150 is to be formed may be left by patterning using a photolithography method. Before the underlying insulating layer 70 is formed, an insulating material serving as a grinding protection layer may be formed on the substrate 90.

As illustrated in FIG. 5B, a seed layer 81 is formed on the underlying insulating layer 70. Specifically, a material (for example, titanium/copper alloys) of the seed layer 81 is formed on the upper surface of the underlying insulating layer 70 by sputtering, and patterned by a photolithography method to form the seed layer 81.

As illustrated in FIG. 5C, a wall portion 32 to be a part of the covering insulating layer is formed on the underlying insulating layer 70. The wall portion 32 is formed of, for example, a photosensitive permanent photoresist. The photosensitive permanent photoresist is a photoresist that is not removed after processing. Specifically, a photosensitive permanent photoresist is laminated on the underlying insulating layer 70, and exposed and developed. As a result, the material of the portion not exposed is removed to form the wall portion 32.

As illustrated in FIG. 5D, electrolytic plating is performed while power is supplied to the seed layer 81. As a result, the inductor wiring 150 is formed between the wall portions 32.

As illustrated in FIG. 5E, the top surface portion 31 of the covering insulating layer 30 is formed on a part of the top surface 150a of the inductor wiring 150. Specifically, a dry film resist (DFR) is laminated on the top surface 150a of the inductor wiring 150, and exposed and developed. As a result, the material of the portion not exposed is removed to form the top surface portion 31. At this time, the dry film resist located at the portion where the top surface 150a of the inductor wiring 150 and the second magnetic layer 12 are in contact with each other is removed. As a result, when the second magnetic layer 12 is pressure-bonded in a subsequent step, a part of the top surface 150a of the inductor wiring 150 comes into contact with the second magnetic layer.

As illustrated in FIG. 5F, a seed layer 82 is formed by sputtering so as to cover the exposed portion of the top surface 150a of the inductor wiring 150 and the top surface portion 31 and the wall portion 32 of the covering insulating layer 30. At this time, since the distance between the end surface of the wall portion 32 of the covering insulating layer 30 and the top surface 150a of the inductor wiring 150 is 20 μm or less, a sputtered film can be favorably attached even at a step portion between the upper end surface of the wall portion 32 and the top surface 150a, and the seed layer 82 can be favorably formed.

As illustrated in FIG. 5G, the first via wiring 212 and the first columnar wiring 211 are formed on the outer peripheral end 152 of the inductor wiring 150. Specifically, a resist film 320 is formed on the seed layer 82, and an opening is provided at a position of the resist film 320 corresponding to the first via wiring 212. At this time, since the distance between the end surface of the wall portion 32 of the covering insulating layer 30 and the top surface 150a of the inductor wiring 150 is 20 μm or less, the resist film 320 can be formed into a desired shape. As a result, the first via wiring 212 and the first columnar wiring 211 can also have desired shapes. Thereafter, electrolytic plating is performed while power is supplied to the seed layer 82, and a plating layer is formed in the opening. As a result, the first via wiring 212 and the first columnar wiring 211 are formed in the opening.

As illustrated in FIG. 5H, the resist film 320 is peeled off, the exposed seed layer 82 is removed, and the second magnetic layer 12 is pressure-bonded from above the substrate 90 toward the inductor wiring 150. As a result, the inductor wiring 150, the underlying insulating layer 70, the covering insulating layer 30, and the first columnar wiring 211 are covered with the second magnetic layer 12.

As illustrated in FIG. 5I, the upper surface of the second magnetic layer 12 is ground to expose the upper surface of the first columnar wiring 211.

As illustrated in FIG. 5J, the covering film 60 is formed on the upper surface of the second magnetic layer 12. The covering film 60 is formed of, for example, a solder resist. Thereafter, the substrate 90 is ground to expose the lower surface of the underlying insulating layer 70. Thereafter, the first magnetic layer 11 is pressure-bonded from below the underlying insulating layer 70 toward the inductor wiring 150. As a result, the lower surface of the underlying insulating layer 70 is covered with the first magnetic layer 11. Thereafter, the lower surface of the first magnetic layer 11 is ground to adjust the thickness of the first magnetic layer 11. Thereafter, the first external terminal 51 is formed so as to cover the upper surface of the first columnar wiring 211. The first external terminal 51 has a three-layer structure of Cu/Ni/Au, for example, formed by electroless plating. Thereafter, the inductor component 1 is divided by a dicer or the like to manufacture the inductor component 1.

### Second Embodiment

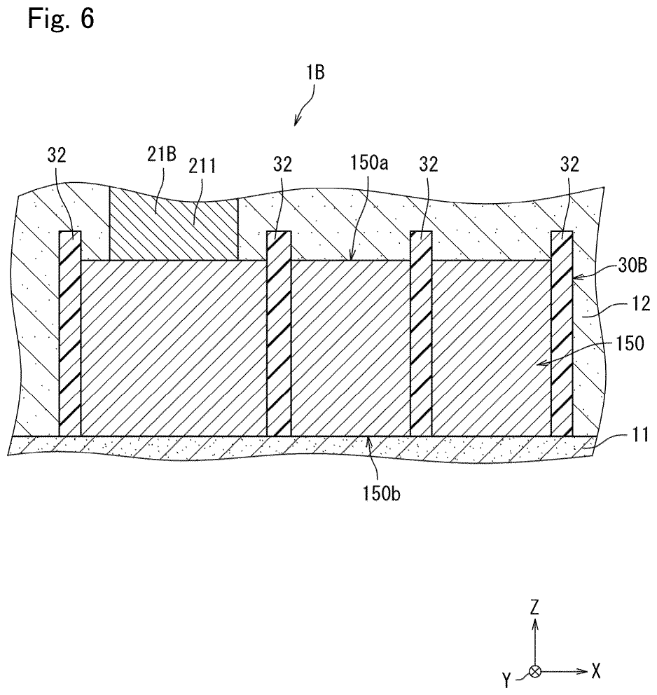

FIG. 6 is a schematic cross-sectional view illustrating a second embodiment of an inductor component. FIG. 6 corresponds to a cross-sectional view taken along line II-II in FIG. 1. In FIG. 6, description of a second extended wiring side is omitted for convenience. The second embodiment is different from the first embodiment in that the top surface portion of the covering insulating layer and the underlying insulating layer are not provided. This different configuration will be described below. The other configurations are the same as those of the first embodiment, and are denoted by the same reference numerals as those of the first embodiment, and the description thereof will be omitted.

As illustrated in FIG. 6, a covering insulating layer 30B includes only a wall portion 32 and does not include a top surface portion. As a result, the entire top surface 150a of the inductor wiring 150 is in contact with the second magnetic layer 12. A first extended wiring 21B does not have a via wiring, and the first columnar wiring 211 is directly connected to the inductor wiring 150. According to this configuration, since the volume of the second magnetic layer 12 can be further increased, the inductance value of the inductor component 1B can be further improved.

In the inductor component 1i, the underlying insulating layer is not provided, and the upper surface of the first magnetic layer 11 and the lower surface of the second magnetic layer 12 are in contact with each other. As a result, the entire bottom surface 150b of the inductor wiring 150 is in contact with the first magnetic layer 11. According to this configuration, since the thickness of the first magnetic layer 11 in the Z direction can be increased as compared with the case where the underlying insulating layer is provided, the volume of the first magnetic layer 11 can be further increased, and the inductance value of the inductor component 1B can be further improved.

The inductor component 1B can be manufactured, for example, by removing the underlying insulating layer 70 after grinding the substrate 90 in the step illustrated in FIG. 5J without providing the top surface portion 31 in the step illustrated in FIG. 5E.

### Third Embodiment

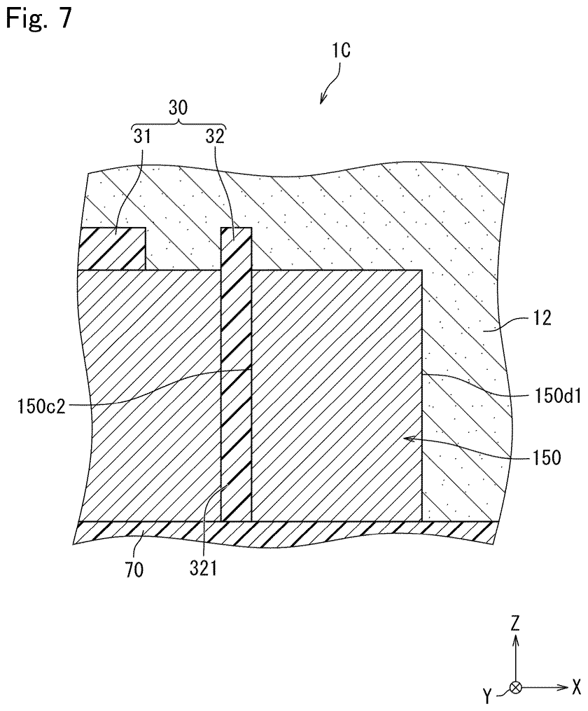

FIG. 7 is a schematic cross-sectional view illustrating a third embodiment of an inductor component. FIG. 7 corresponds to FIG. 3. The third embodiment is different from the first embodiment in that a wall portion of a covering insulating layer is not provided on an inner peripheral surface of an innermost periphery of an inductor wiring. This different configuration will be described below. The other configurations are the same as those of the first embodiment, and are denoted by the same reference numerals as those of the first embodiment, and the description thereof will be omitted.

As illustrated in FIG. 7, at least a part of the inner peripheral surface 150d1 of the innermost periphery of the inductor wiring 150 is in contact with the second magnetic layer 12. In this embodiment, the entire inner peripheral surface 150d1 of the innermost periphery of the inductor wiring 150 is in contact with the second magnetic layer 12. According to this configuration, since the volume of the second magnetic layer 12 can be further increased, the inductance value of the inductor component 1C can be further improved.

The inductor component 1C can be manufactured, for example, by not providing the wall portion 32 corresponding to the position of the inner peripheral surface of the innermost periphery of the inductor wiring in the step illustrated in FIG. 5C.

### Fourth Embodiment

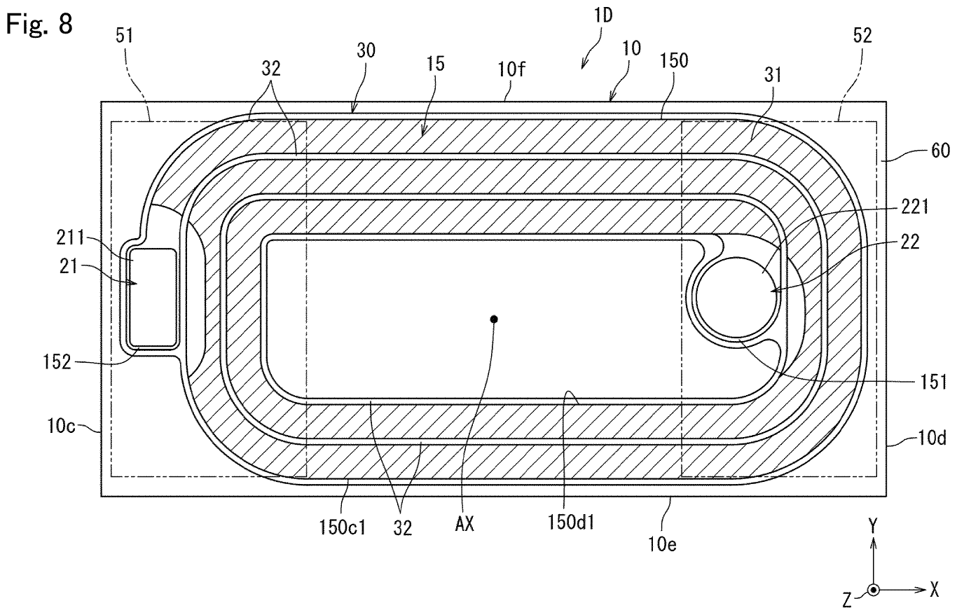

FIG. 8 is a schematic plan view illustrating a fourth embodiment of an inductor component. FIG. 8 corresponds to FIG. 1. The fourth embodiment is different from the first embodiment mainly in the position where the top surface portion of the covering insulating layer is provided. This different configuration will be described below. The other configurations are the same as those of the first embodiment, and are denoted by the same reference numerals as those of the first embodiment, and the description thereof will be omitted. In FIG. 8, hatching is applied to a position where the top surface portion of the covering insulating layer exists for convenience.

As illustrated in FIG. 8, when a direction from the bottom surface to the top surface of the inductor wiring 150 in the axis AX direction is defined as a first direction, the first and second extended wirings 21 and 22 connected to the top surface at the end (that is, the inner peripheral end 151 and the outer peripheral end 152) in the extending direction of the inductor wiring 150, extending in the first direction, and exposed from the outer surface of the element body 10 are further provided, and the covering insulating layer 30 (that is, the top surface portion 31) provided on a part of the top surface of the inductor wiring 150 is separated from the first and second extended wirings 21 and 22.

Specifically, the top surface portion 31 of the covering insulating layer 30 is provided on the entire top surface of the inductor wiring 150 except for regions around the first and second extended wirings 21 and 22. Note that the top surface portion 31 of the covering insulating layer 30 may be provided in a part of a portion excluding a region around the first and second extended wirings 21 and 22 as long as it is separated from the first and second extended wirings 21 and 22. In this embodiment, since the top surface portion 31 of the covering insulating layer 30 is not provided in a region around the first and second extended wirings 21 and 22, unlike the first embodiment, the first and second extended wirings 21 and 22 do not have the first and second via wirings 212 and 222. That is, the bottom surfaces of the first and second columnar wirings 211 and 221 of the first and second extended wirings 21 and 22 are in direct contact with the top surface of the inductor wiring 150.

According to the above configuration, the top surface portion 31 can be provided at a desired position where a short circuit is likely to occur between the inductor wirings 150, and the first and second extended wirings 21 and 22 do not have the first and second via wirings 212 and 222 as in FIG. 1, so that the contact area between the first and second extended wirings 21 and 22 (that is, the first and second columnar wirings 211 and 221) and the inductor wiring 150 can be increased, the fixing strength between the first and second extended wirings 21 and 22 and the inductor wiring 150 is increased, and defects such as disconnection due to external stress can be suppressed.

Note that the present disclosure is not limited to the above-described embodiments, and can be modified in design without departing from the gist of the present disclosure. For example, the respective feature points of the first to fourth embodiments may be variously combined.

In the above embodiments, the first and second extended wirings, the first and second external terminals, and the covering film are provided, but these members are not essential, and may not be provided, or may be replaced with other members.

In the above embodiments, the inductor wiring has one layer, but may have two or more layers. In this case, the “top surface of the inductor wiring” refers to the top surface of the uppermost inductor wiring. The “bottom surface of the inductor wiring” refers to the bottom surface of the lowermost inductor wiring.

In the above embodiments, at least a part of the top surface of the inductor wiring is in contact with the second magnetic layer, but the entire top surface of the inductor wiring may be covered with the covering insulating layer, and at least a part of the bottom surface of the inductor wiring may be in contact with the first magnetic layer. In this case, the top surface of the inductor wiring corresponds to an example of a “second surface” described in the claims, and the bottom surface of the inductor wiring corresponds to an example of a “first surface” described in the claims.

In the above embodiments, the wall portion of the covering insulating layer exists in the entire region between the adjacent turns of the inductor wiring, but the second magnetic layer may exist between the adjacent turns. Specifically, in the cross section orthogonal to the extending direction of the inductor wiring, the wall portion of the covering insulating layer may be provided on at least one of both side surfaces of the inductor wiring, and the second magnetic layer may exist between adjacent turns.

### EXAMPLES

Chips in which the distance h between the top surface of the inductor wiring and the end surface in the first direction of the wall portion of the covering insulating layer was changed to 3 μm, 4 μm, 5 μm, 6 μm, 7 μm, and 10 μm were prepared, and a moisture resistance load test was performed on each chip. In the humidity load test, a current was passed through the chip under a high temperature and high humidity environment, and the insulation resistance of the inductor wiring was measured after a predetermined time. Conditions for the moisture resistance load test were 85° C., 85% RH, 1 A, and 500 hr. Among the 15 chips, the number of chips having a normal insulation resistance (number of good chips) was investigated. The test results are shown in Table 1.

TABLE 1

| | Distance h (μm) | | | | | |
|---|---|---|---|---|---|---|
| | 3 | 4 | 5 | 6 | 7 | 10 |
| Number of good chips | 12 | 14 | 15 | 15 | 15 | 15 |
| Number of defective chips | 3 | 1 | 0 | 0 | 0 | 0 |

Chips in which the distance h between the top surface of the inductor wiring and the end surface in the first direction of the wall portion of the covering insulating layer was changed to 10 μm, 15 μm, 20 μm, 25 am, and 30 μm were prepared, and the presence or absence of a defect in the manufacturing process was examined. Specifically, for the sample in which the seed layer was formed by sputtering after the wall portion of the covering insulating layer was formed, the deposition state of the seed layer was observed with an optical microscope. In addition, for the sample in which the resist film was formed after the seed layer was formed, the deposition state of the resist film was observed with an optical microscope. Then, among the 15 chips, the number of chips in which the deposition states of the seed layer and the resist film were normal (number of good chips) was investigated. The investigation results are shown in Table 2.

TABLE 2

| | Distance h (μm) | | | | |
|---|---|---|---|---|---|
| | 10 | 15 | 20 | 25 | 30 |
| Number of good chips | 15 | 15 | 15 | 11 | 5 |
| Number of defective chips | 0 | 0 | 0 | 4 | 10 |

As shown in Table 1, when the distance h was 4 μm or less, there was a chip having an abnormal insulation resistance. As shown in Table 2, when the distance h was 25 μm or more, there was a chip in which a defect in the manufacturing process occurred.

The present disclosure includes the following aspects.

<1> An inductor component comprising an element body including a magnetic layer; a coil disposed in the element body and having a shaft; and an insulating layer covering a part of an outer surface of the coil. The coil includes an inductor wiring wound along a plane orthogonal to the axis, the inductor wiring has a first surface and a second surface facing each other in the axial direction, and at least a part of the first surface of the inductor wiring is in contact with the magnetic layer.

<2> The inductor component according to <1>, in which the entire first surface of the inductor wiring is in contact with the magnetic layer.

<3> The inductor component according to <1> or <2>, in which the entire second surface of the inductor wiring is in contact with the magnetic layer.

<4> The inductor component according to any one of <1> to <3>, in which, in a cross section orthogonal to an extending direction of the inductor wiring, the inductor wiring has both side surfaces connecting the first surface and the second surface, and the insulating layer has a wall portion provided on at least one of the both side surfaces.

<5> The inductor component according to <4>, in which when a direction from the second surface to the first surface of the inductor wiring in the axial direction is a first direction, an end surface of the wall portion in the first direction is located closer to the first direction than a position of the first surface of the inductor wiring.

<6> The inductor component according to <5>, in which a distance in the first direction between the first surface of the inductor wiring and the end surface in the first direction of the wall portion is 5 μm or more and 20 μm or less (i.e., from 5 μm to 20 m).

<7> The inductor component according to any one of <1> to <6>, in which at least a part of an inner peripheral surface of an innermost periphery of the inductor wiring is in contact with the magnetic layer.

<8> The inductor component according to any one of <1> to <6>, in which, in a cross section orthogonal to an extending direction of the inductor wiring, the inductor wiring has both side surfaces connecting the first surface and the second surface, the side surfaces of the inductor wiring located on an innermost periphery include an inner peripheral surface of the innermost periphery and an outer peripheral surface facing the inner peripheral surface, and the insulating layer has a wall portion provided at least on each of the inner peripheral surface and the outer peripheral surface. Also, when a direction from the second surface to the first surface of the inductor wiring in the axial direction is a first direction, an end surface in the first direction of the wall portion provided on the inner peripheral surface is located on a second direction side opposite to the first direction with respect to the end surface in the first direction of the wall portion provided on the outer peripheral surface.

<9> The inductor component according to <8>, in which the end surface in the first direction of the wall portion provided on the inner peripheral surface is located on the same plane as the first surface of the inductor wiring.

<10> The inductor component according to any one of <1> to <9>, in which the insulating layer is provided at least on a part of the first surface of the inductor wiring.

<11> The inductor component according to <10>, further comprising an extended wiring that is connected to the first surface at an end in an extending direction of the inductor wiring and extends in the first direction to be exposed from an outer surface of the element body when a direction from the second surface toward the first surface of the inductor wiring in the axial direction is defined as a first direction. The insulating layer provided on a part of the first surface of the inductor wiring is provided over a range of 80 μm or more from a peripheral edge of the extended wiring in the first surface.

<12> The inductor component according to <10>, further comprising an extended wiring that is connected to the first surface at an end in an extending direction of the inductor wiring and extends in the first direction to be exposed from an outer surface of the element body when a direction from the second surface toward the first surface of the inductor wiring in the axial direction is defined as a first direction, in which the insulating layer provided on a part of the first surface of the inductor wiring is separated from the extended wiring.

What is claimed is:

1. An inductor component comprising:
an element body comprising a magnetic layer;
a coil in the element body and having an axis; and
an insulating layer covering a part of an outer surface of the coil,
wherein
the coil comprises an inductor wiring wound along a plane orthogonal to the axis,
the inductor wiring has a first surface and a second surface facing each other in the axial direction, and
at least a part of the first surface of the inductor wiring is in contact with the magnetic layer.

2. The inductor component according to claim 1, wherein
the entire first surface of the inductor wiring is in contact with the magnetic layer.

3. The inductor component according to claim 1, wherein
the entire second surface of the inductor wiring is in contact with the magnetic layer.

4. The inductor component according to claim 1, wherein
in a cross section orthogonal to an extending direction of the inductor wiring, the inductor wiring has both side surfaces connecting the first surface and the second surface, and
the insulating layer has a wall portion on at least one of the both side surfaces.

5. The inductor component according to claim 4, wherein
when a direction from the second surface to the first surface of the inductor wiring in the axial direction is a first direction, an end surface of the wall portion in the first direction is closer to the first direction than a position of the first surface of the inductor wiring.

6. The inductor component according to claim 5, wherein
a distance in the first direction between the first surface of the inductor wiring and the end surface in the first direction of the wall portion is from 5 μm to 20 μm.

7. The inductor component according to claim 1, wherein
at least a part of an inner peripheral surface of an innermost periphery of the inductor wiring is in contact with the magnetic layer.

8. The inductor component according to claim 1, wherein
in a cross section orthogonal to an extending direction of the inductor wiring,
the inductor wiring has both side surfaces connecting the first surface and the second surface,
the side surfaces of the inductor wiring on an innermost periphery comprise an inner peripheral surface of the innermost periphery and an outer peripheral surface facing the inner peripheral surface,
the insulating layer has a wall portion at least on each of the inner peripheral surface and the outer peripheral surface, and
when a direction from the second surface to the first surface of the inductor wiring in the axial direction is a first direction, an end surface in the first direction of the wall portion on the inner peripheral surface is on a second direction side opposite to the first direction with respect to the end surface in the first direction of the wall portion on the outer peripheral surface.

9. The inductor component according to claim 8, wherein
the end surface in the first direction of the wall portion on the inner peripheral surface is on the same plane as the first surface of the inductor wiring.

10. The inductor component according to claim 1, wherein
the insulating layer is at least on a part of the first surface of the inductor wiring.

11. The inductor component according to claim 10, further comprising:
an extended wiring that is connected to the first surface at an end in an extending direction of the inductor wiring and extends in a first direction and is exposed from an outer surface of the element body when a direction from the second surface toward the first surface of the inductor wiring in the axial direction is defined as the first direction,
wherein the insulating layer on a part of the first surface of the inductor wiring is over a range of 80 μm or more from a peripheral edge of the extended wiring in the first surface.

12. The inductor component according to claim 10, further comprising:
an extended wiring that is connected to the first surface at an end in an extending direction of the inductor wiring and extends in a first direction and is exposed from an outer surface of the element body when a direction from the second surface toward the first surface of the inductor wiring in the axial direction is defined as the first direction,
wherein the insulating layer on a part of the first surface of the inductor wiring is separated from the extended wiring.

13. The inductor component according to claim 2, wherein
the entire second surface of the inductor wiring is in contact with the magnetic layer.

14. The inductor component according to claim 2, wherein
in a cross section orthogonal to an extending direction of the inductor wiring, the inductor wiring has both side surfaces connecting the first surface and the second surface, and
the insulating layer has a wall portion on at least one of the both side surfaces.

15. The inductor component according to claim 3, wherein
in a cross section orthogonal to an extending direction of the inductor wiring, the inductor wiring has both side surfaces connecting the first surface and the second surface, and
the insulating layer has a wall portion on at least one of the both side surfaces.

16. The inductor component according to claim 2, wherein
at least a part of an inner peripheral surface of an innermost periphery of the inductor wiring is in contact with the magnetic layer.

17. The inductor component according to claim 3, wherein
at least a part of an inner peripheral surface of an innermost periphery of the inductor wiring is in contact with the magnetic layer.

18. The inductor component according to claim 2, wherein
in a cross section orthogonal to an extending direction of the inductor wiring,
the inductor wiring has both side surfaces connecting the first surface and the second surface,
the side surfaces of the inductor wiring on an innermost periphery comprise an inner peripheral surface of the innermost periphery and an outer peripheral surface facing the inner peripheral surface,
the insulating layer has a wall portion at least on each of the inner peripheral surface and the outer peripheral surface, and
when a direction from the second surface to the first surface of the inductor wiring in the axial direction is a first direction, an end surface in the first direction of the wall portion on the inner peripheral surface is on a second direction side opposite to the first direction with respect to the end surface in the first direction of the wall portion on the outer peripheral surface.

19. The inductor component according to claim 3, wherein
in a cross section orthogonal to an extending direction of the inductor wiring,
the inductor wiring has both side surfaces connecting the first surface and the second surface,
the side surfaces of the inductor wiring on an innermost periphery comprise an inner peripheral surface of the innermost periphery and an outer peripheral surface facing the inner peripheral surface,
the insulating layer has a wall portion at least on each of the inner peripheral surface and the outer peripheral surface, and
when a direction from the second surface to the first surface of the inductor wiring in the axial direction is a first direction, an end surface in the first direction of the wall portion on the inner peripheral surface is on a second direction side opposite to the first direction with respect to the end surface in the first direction of the wall portion on the outer peripheral surface.

20. The inductor component according to claim 2, wherein
the insulating layer is at least on a part of the first surface of the inductor wiring.
